(19) United States
(12) Patent Application Publication
(10) Pub. No.: US 2022/0162846 A1
(43) Pub. Date: May 26, 2022

(54) BAFFLE WALLS WITH PRESSURE RELIEF

(71) Applicant: Enduro Composites, Inc, Houston, TX (US)

(72) Inventors: Kevin Schmit, Houston, TX (US); Jeremy Chaisson, Houston, TX (US)

(21) Appl. No.: 17/533,620

(22) Filed: Nov. 23, 2021

Related U.S. Application Data
(60) Provisional application No. 63/117,362, filed on Nov. 23, 2020.

(51) Int. Cl. E03F 5/10; C02F 1/00; E02D 29/02

(52) U.S. Cl. CPC E03F 5/105; C02F 2201/002; E02D 29/02; C02F 1/00

(57) ABSTRACT

The instant application pertains to a pressure relief door for a waste water treatment system. The pressure relief door comprises a pressure relief door frame configured to be attached to a baffle wall or a tank floor or a tank cover. A pressure relief door cover is attached to the pressure relief door frame with a hinge and axle. At least one torsion spring is attached to the pressure relief door cover so that the pressure relief door is allowed to open only when the pressure on the pressure relief door cover exceeds a predetermined pressure.

### CROSS-REFERENCE TO RELATED APPLICATIONS

This application claims priority to U.S. provisional application Ser. No. 63/117,362 which application is incorporated herein by reference.

### FIELD OF THE INVENTION

This application is related to baffle walls used in, for example, aeration tanks for waste water treatment.

### BACKGROUND AND SUMMARY OF THE INVENTION

Baffle wall systems are often designed for potable water and wastewater treatment flow control.

The instant application improves upon conventional baffle and partition walls by providing a system and process for selectively reducing water pressure exerted on one or more sections of the baffle or partition wall.

Baffle walls control the flow of water and increase residence time while partition walls separate zones or enhance mixing. Baffle and partition walls are generally comprised of fiberglass panels, angles, and framing members for strength and corrosion resistance.

The instant application improves upon conventional baffle and partition walls by providing a system and process for selectively reducing water pressure exerted on one or more sections of the baffle or partition wall. A device includes a framing member, a stop, and a pressure relief cover. The device may further include a gasket, an axle, a torsion spring, and one or more restraining clamps. The present application also pertains to components for the fiberglass reinforced plastic (FRP) baffle wall system including FRP baffle wall panels; FRP columns; FRP angles; column base plates/angles; fasteners and connections.

### BRIEF DESCRIPTION OF THE DRAWINGS

FIG. 1 is a drawing of a baffle wall for an aeration tank.

FIG. 2A depicts a representative embodiment of a system and process for selectively reducing water pressure exerted on one or more sections of the baffle or partition wall.

FIG. 2B depicts a further representative embodiment of a system and process for selectively reducing water pressure exerted on one or more sections of the baffle or partition wall.

FIG. 2C depicts a labeled representative embodiment of a system and process for selectively reducing water pressure exerted on one or more sections of the baffle or partition wall.

FIG. 3 shows a pressure relief door frame.

FIG. 4 shows a torsion spring moment arm of the pressure relief door frame of FIG. 3.

FIG. 5 shows a normal operation condition of the pressure relief door frame of FIG. 3.

FIG. 6 shows a upset operation condition of the pressure relief door frame of FIG. 3.

FIG. 7 shows a pressure relief door.

FIG. 8 shows a typical baffle configuration.

FIG. 9 shows FRP Slideguide “H” baffle series in aeration basin.

FIG. 10A shows baffles to control flow and increase residence time; and FIG. 10B shows partition to separate zones or enhance mixing.

FIG. 11A-1 shows “D” series system of baffle and partition wall system types; and

FIG. 11B-1) shows “H” series system of baffle and partition wall system types.

FIG. 11A-2 shows a different view of “D” series systems of baffle and partition wall system types and FIG. 11B-2 shows a different view of “H” series system of baffle and partition wall system types.

FIG. 12A shows cantilevered column wall; FIG. 12B shows integrated roof; FIG. 12C shows perforated wall; FIG. 12D shows solid wall with bottom void; and FIG. 12E shows doors.

FIG. 13 shows “H” baffle series and columns utilized inside and wastewater chlorine contact basin.

FIG. 14 shows “D” and “H” baffle wall system with top-braced FRP columns flocculation and sedimentation basin.

FIG. 15 shows H″ baffle series stacked as high as 42 ft. in a clearwall reservoir. For installation under existing tank cover, 2 foot wide baffle panels easily pass through access hatches.

FIG. 16 shows bolted installation.

FIG. 17 shows slideguide installation.

FIG. 18 shows a profiled section of “D” structural baffle wall.

FIG. 19 shows “D” structural baffle wall system.

FIG. 20A shows panel slide lap; FIG. 20B shows concrete wall; and FIG. 20C shows 12F12 FRP column.

FIG. 21 shows a profiled section of “H” structural baffle wall.

FIG. 22 shows “H” structural baffle wall system.

FIG. 23 shows baffle panel stacking.

FIG. 24A shows Slideguide concrete wall; FIG. 24B shows Slideguide 12S12 FRP column; FIG. 24C bolted 12F12 FRP column; and FIG. 24D shows bolted 12S12 FRP column.

### DETAILED DESCRIPTION

The description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

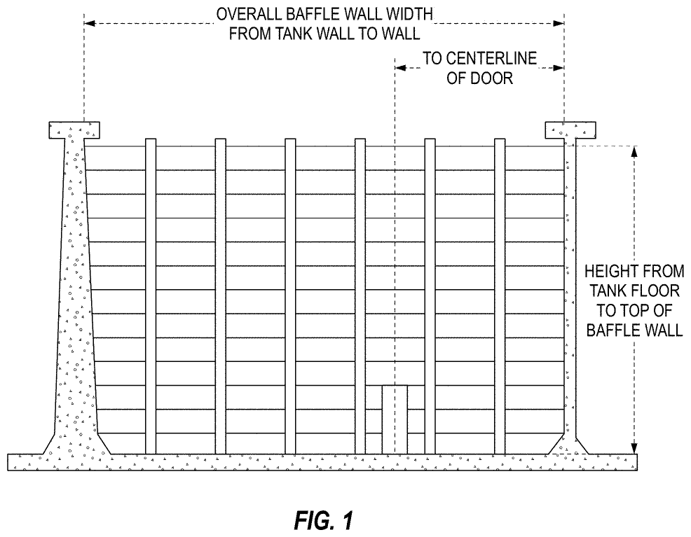

FIG. 1 shows a tank wall, floor, and columns with an array of panels between columns that form a baffle wall.

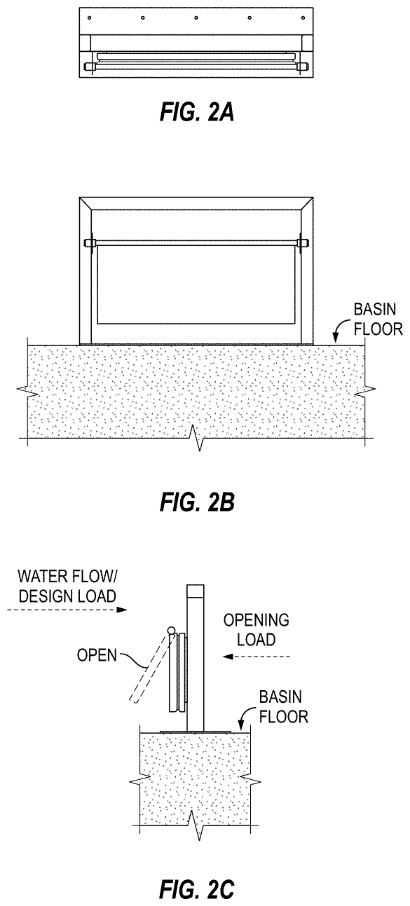

FIG. 2 shows an embodiment of a system and process for selectively reducing water pressure exerted on one or more sections of the baffle or partition wall. Specifically, in FIG. 2 at least one insert in the array of panels is configured to open or selectively open to release pressure. If desired, the insert can be configured to automatically (or manually) open at a predetermined pressure and then automatically (or manually) close when a second predetermined pressure, e.g., lower than the first, is reached. The specific configuration is not particularly critical so long as the water pressure exerted on a specific section is controlled within a desired limit. Thus, the materials, configuration, sizes of the system's elements, and the like may vary depending upon the tank, the materials, the type of water and/or other material being contained, and other considerations. Thus, in some embodiments various hinges may be used on the insert such as a strap hinge, a butt hinge, spring-loaded hinge, a concealed hinge, a piano hinge, an offset hinge, an overlay hinge, a barrel hinge, a scissor hinge, a gate hinge, and combinations thereof. Of course, alternatives to inserts with hinges may be employed such as vents or any other barrier that may be selectively opened or closed to control fluid pressure.

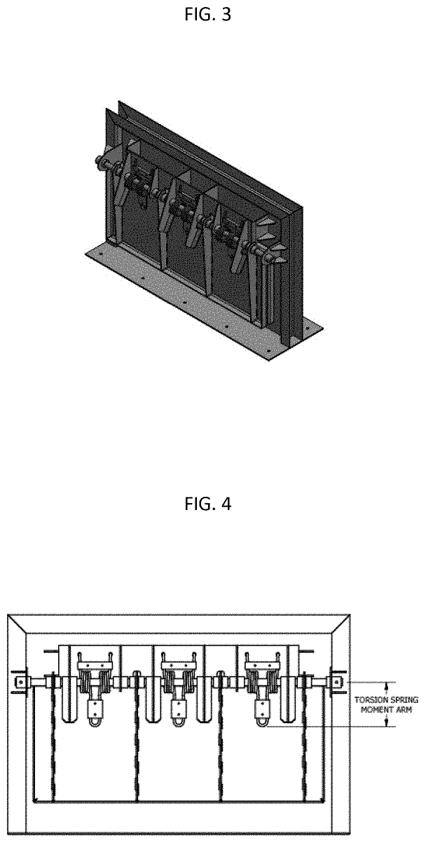

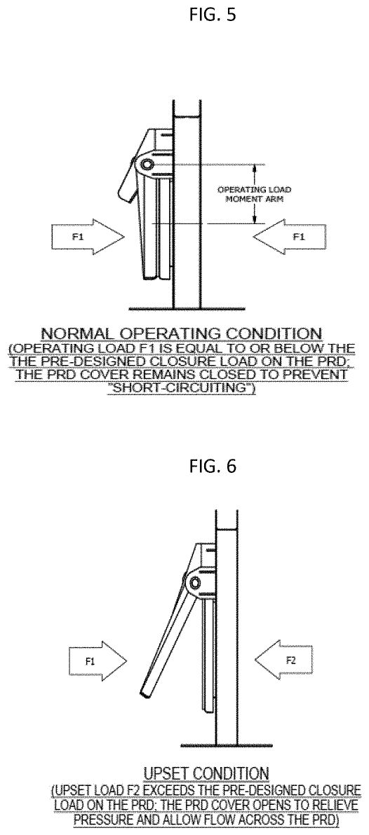

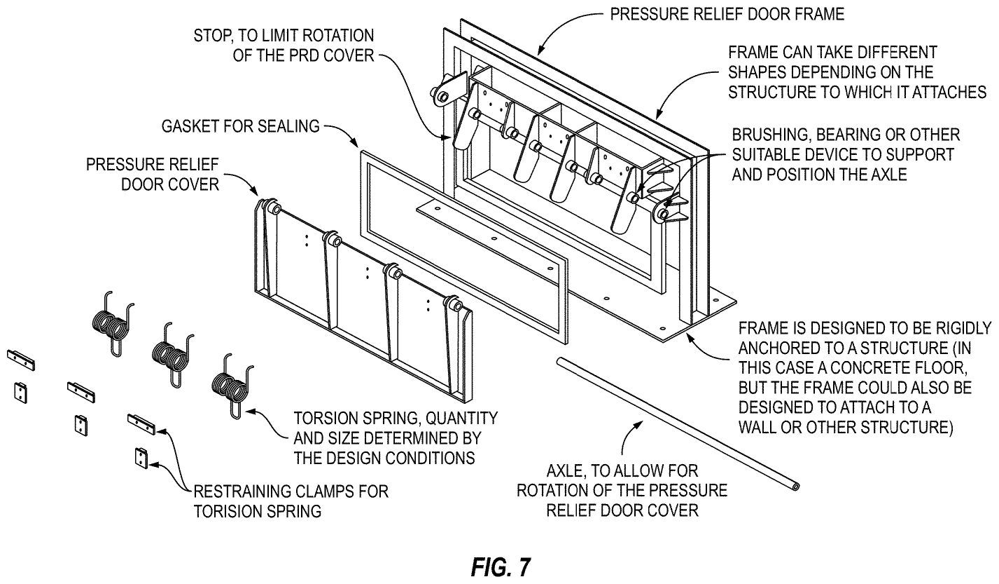

FIG. 3 shows a pressure relief door frame. FIG. 4 shows a torsion spring moment arm of the pressure relief door frame of FIG. 3. FIG. 5 shows a normal operation condition of the pressure relief door frame of FIG. 3. FIG. 6 shows a upset operation condition of the pressure relief door frame of FIG. 3. FIG. 7 shows a pressure relief door.

As shown in FIGS. 3-5, under the normal operation condition of the pressure relief door frame, operating load F1 is equal to or below the pre-designed closure load on the pressure relief door (PRD). The PRD cover remains closed to prevent “short-circuiting”. As shown in FIG. 6, under the upset operation condition of the pressure relief door frame, upset load F2 exceeds the pre-designed closure load on the PRD. The PRD cover opens to relieve pressure and allow flow across the PRD.

As shown in FIG. 7, the pressure relief door includes the pressure relief door frame, a stop to limit rotation of the PRD cover, a gasket for sealing, a pressure relief door cover, an axle to allow rotation of the PRD cover, torsion springs, and restraining clamps for torsion spring. The pressure relief door frame is designed to be rigidly anchored to a structure (in this case a concrete floor, but the frame can also be designed to attach to a wall or other structure). The pressure relief door frame also can take different shapes depending on the structure to which it attaches. The pressure relief door frame includes a bushing, bearing or other suitable device to support and position an axle.

The PRD device resists pressure (or other forces and/or moments) and minimizes short-circuiting (i.e. the flow of water across the device) while in a pre-defined normal operating condition but that also relieves pressure (or other forces and/or moments) and allows for short-circuiting (i.e. for water to flow across the device) while in a pre-defined upset condition.

The PRD device also, once open to relieve pressure and allow for short-circuiting, reverts to its closed position once the upset condition no longer exists.

The PRD device also functions while in a completely submerged condition with no external control from an operator or other device.

The PRD device operates in a very narrow pressure range. Normal operating conditions are up to 0.433 psi (12″ w.d. or 62.4 psf). Upset conditions are 0.072 psi (2″ w.d. or 10.4 psf) or more above the normal operating conditions.

The PRD device, while operating in a very narrow pressure range, also allows for flow rates of 1,000 gpm or more while in the open (upset) condition.

The PRD device does not rely on a piston nor diaphragm as a sensing element.

FRP Structural Baffle & Partition Walls

The scope of this specification may include materials for the fiberglass reinforced plastic (FRP) Baffle wall system including FRP baffle wall panels; FRP columns; FRP angles; column base plates/angles; fasteners and connections.

The structural baffle and partition wall systems are specifically designed for potable water and wastewater treatment flow control. The baffle and partition walls are pre-engineered systems composed of fiberglass reinforced plastic baffle panels, angles and framing members. The baffle wall systems offer industry-leading design flexibility in addition to a superior combination of strength and corrosion resistance.

All the baffle and partition wall systems are certified per NSF/ANSI Standard 61 for processing of potable water. The baffle and partition wall systems are an excellent choice for either new or retrofit basins. Their light weight makes them the perfect choice for retrofits, and their design flexibility makes them an excellent choice for new projects as well, allowing easy modification in the event of future process changes.

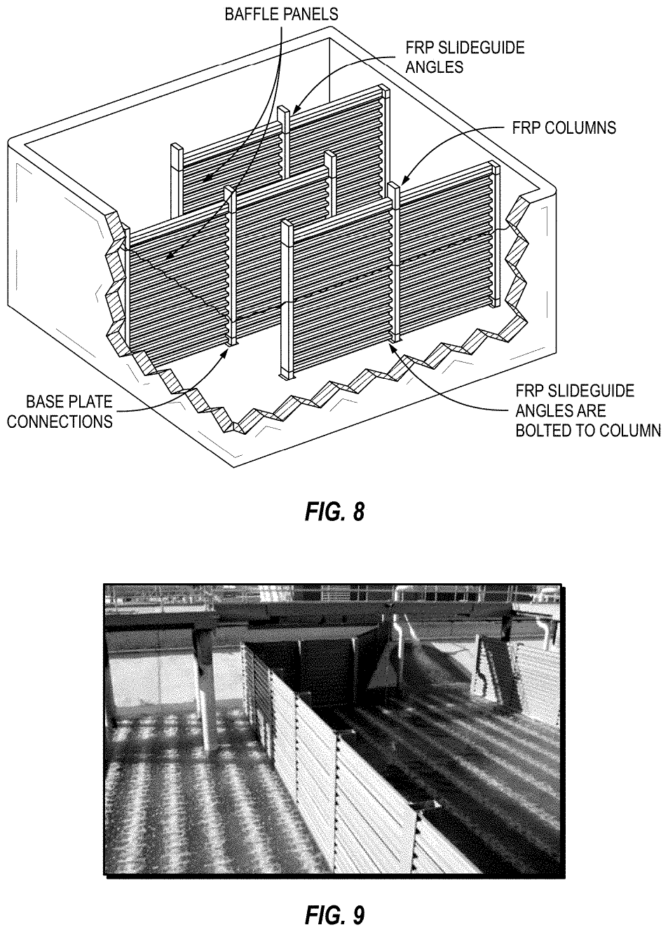

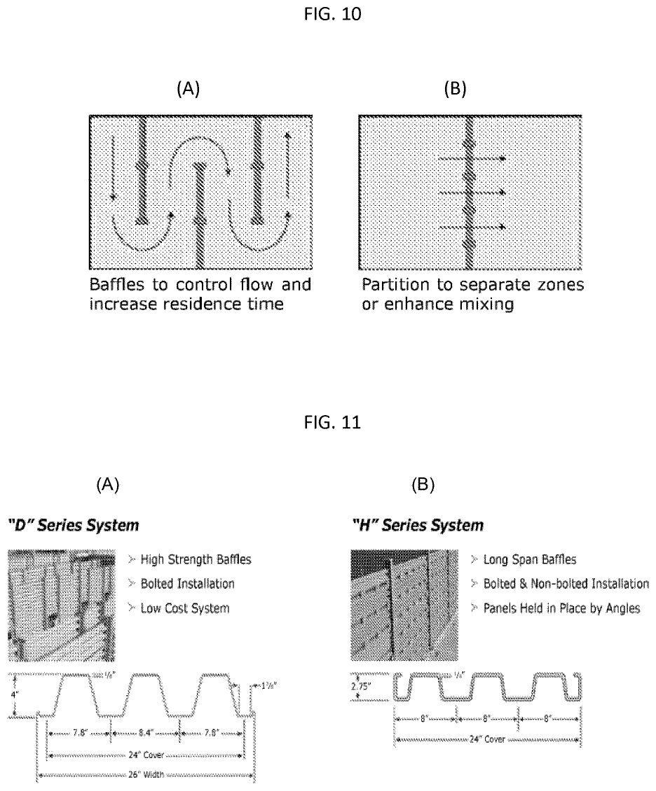

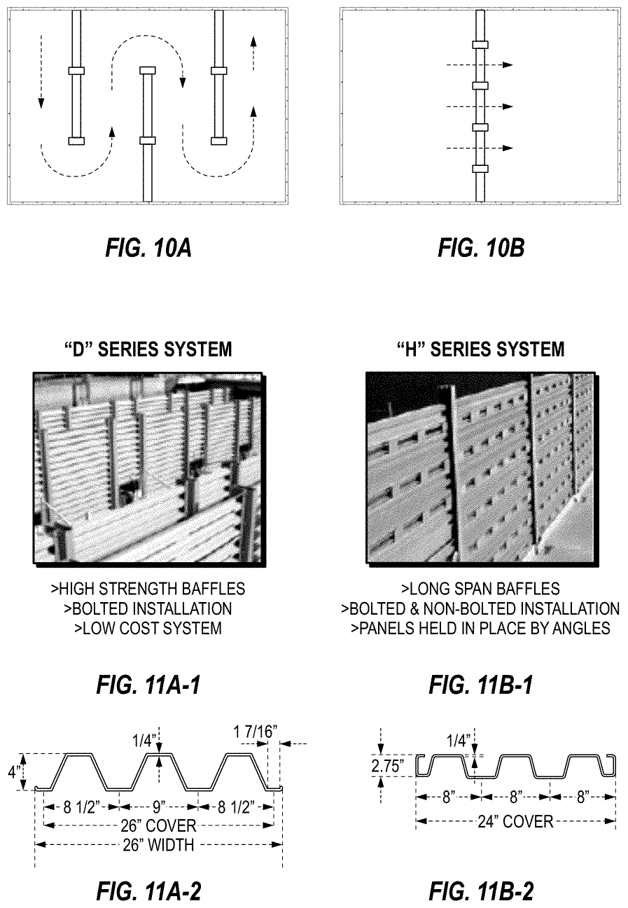

FIG. 8 shows a typical baffle configuration. Slideguide angles and base plates are typically prefabricated to columns. Concrete anchors for Slideguide angles and column base plates may be adhesive type 316 stainless steel. FIG. 9 shows fiberglass reinforced plastic (FRP) Slideguide “H” baffle series in aeration basin. FIG. 10 (A) shows baffles to control flow and increase residence time; and FIG. 10 (B) shows partition to separate zones or enhance mixing.

Baffle and Partition Wall System Types

FIG. 11 (A) shows “D” series system of baffle and partition wall system types; and FIG. 11 (B) shows “H” series system of baffle and partition wall system types.

Benefits of Well-Designed FRP

(1) Corrosion resistance. Designed for corrosive and challenging structural conditions, The baffle and partition walls deliver longer life than concrete, wood, steel or aluminum while eliminating maintenance.

(2) High strength. To ensure high strength and consistent quality, The FRP structural components are manufactured by automated pultrusion process, which utilizes high glass-fiber content and results in unparalleled product consistency.

(3) Lightweight. Weighing 90% less than a comparable concrete system, a FRP baffle wall can reduce loads on tank walls and floors. In addition, its lightweight also eases section removability and installation.

(4) Increased basin volume. With ¼″ maximum thickness, the baffle panels can take up 95% less basin volume compared to 6-8″ thick concrete walls.

(5) Easy reconfiguration. If flow pattern adjustments are needed, the wall systems can be dismantled and relocated to accommodate changes in flow requirements.

System Design

(i) Turn key solutions. The system design offers a single-source responsibility and solution for design, manufacture and fabrication of FRP components. Components are manufactured in custom lengths and factory fabricated that can include pre-drilled holes and attachment of base plates and angles that minimizes field fabrication and installation.

(ii) Customized system. With multiple wall types and system options, experienced technical staff customizes the design to meet the requirements and needs for each project. The baffle walls can include FRP baffle panels (solid or perforated), structural framing, baffle doors, and hardware.

Typical Configuration and Options

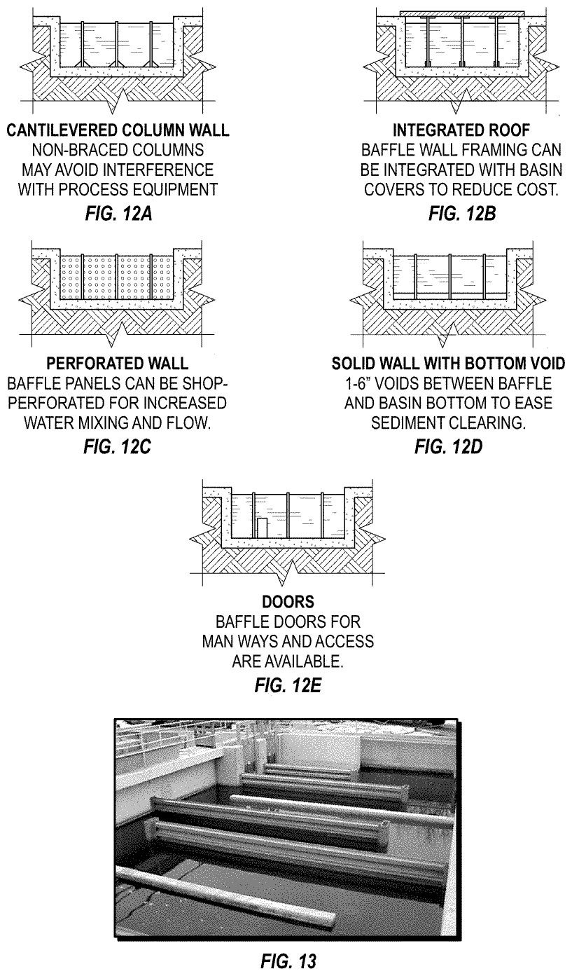

FIG. 12 (a) shows cantilevered column wall; FIG. 12 (b) shows integrated roof; FIG. 12 (c) shows perforated wall; FIG. 12 (d) shows solid wall with bottom void; and FIG. 12 (e) shows doors.

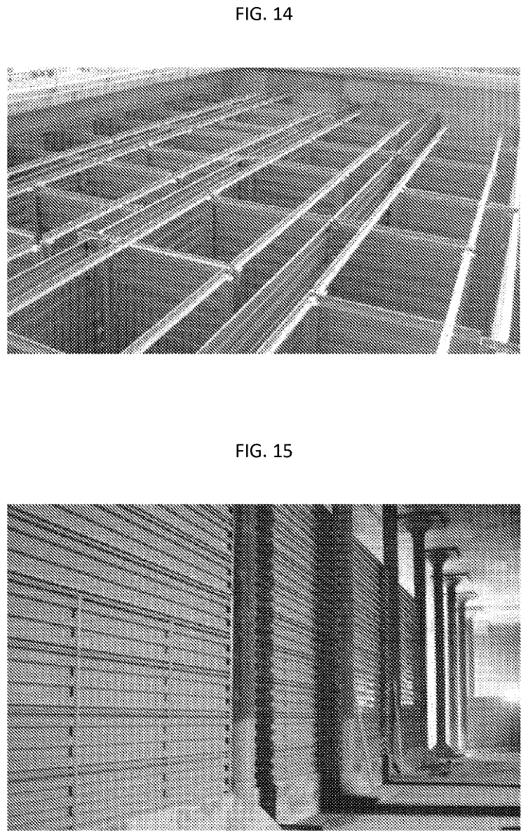

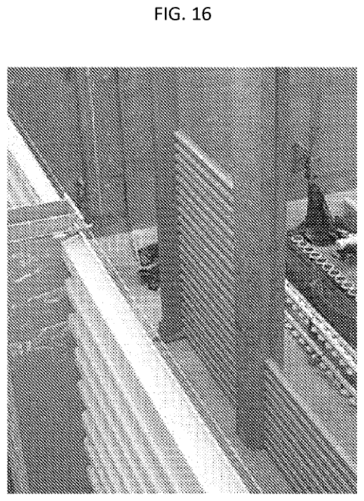

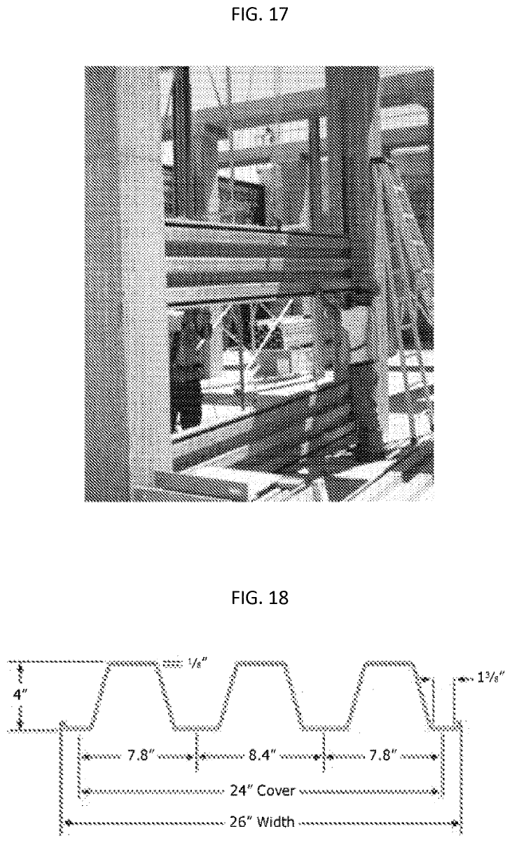

FIG. 13 shows “H” baffle series and columns utilized inside and wastewater chlorine contact basin. FIG. 14 shows “D” and “H” baffle wall system with top-braced FRP columns flocculation and sedimentation basin. FIG. 15 shows H″ baffle series stacked as high as 42 ft. in a clearwall reservoir. For installation under existing tank cover, 2 foot wide baffle panels easily pass through access hatches. FIG. 16 shows bolted installation, as shown in FIG. 16, “D” series baffle panels are nested at sides and fastened to supports. This system requires 50% less angle supports. FIG. 17 shows slideguide installation, as shown in FIG. 17, “H” series baffle panels are stacked from basin bottom to top and do not require fastening to supports.

“D” Structural Baffle and Partition Walls

System Overview

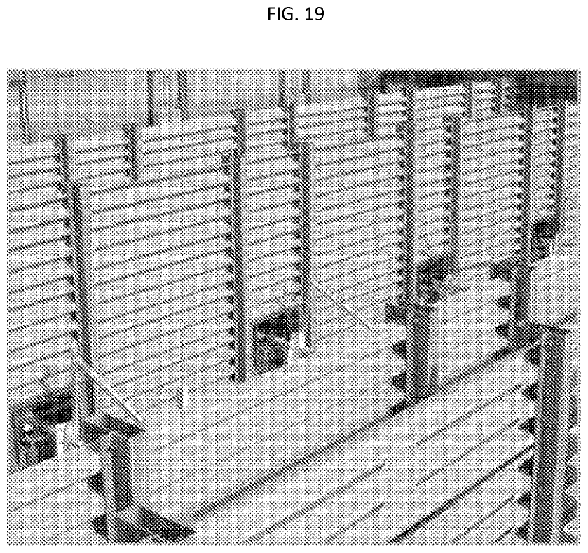

To meet the need for a lower cost, FRP baffle panel that would effectively address rigidity and other structural requirements, Applicant developed its “D” series panel. With an advantaged strength to weight ratio, 4″ deep, profiled section has an extremely efficient design to address demanding wall requirements. (see FIG. 18.) Designed for bolted installation, Applicant's “D” system has a proven track record of outstanding performance for numerous installations. FIG. 18 shows a profiled section of “D” structural baffle wall. FIG. 19 shows “D” structural baffle wall system, wherein solid and slotted with FRP columns sedimentation and flocculation basins.

Representative Details

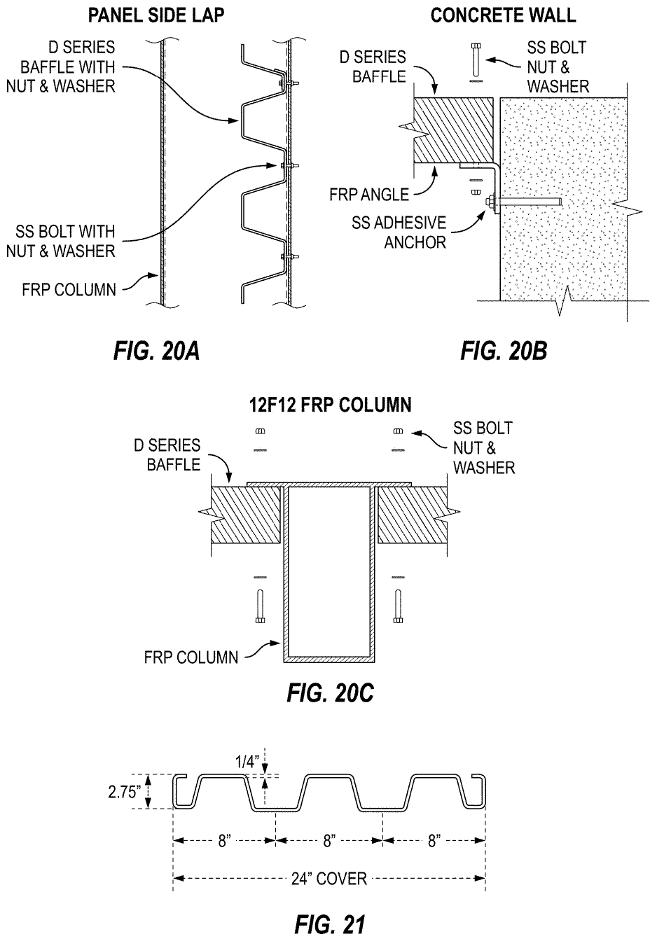

FIG. 20 (a) shows panel slide lap; FIG. 20 (b) shows concrete wall; and FIG. 20 (c) shows 12F12 FRP column.

Table 1 shows load span of the “D” structural baffle and partition walls.

TABLE 1
Load Span Table

| | Water Differential | | | | | | | | | | | | | | | |
|---|---|---|---|---|---|---|---|---|---|---|---|---|---|---|---|---|
| | 1″ | | 2″ | | 3″ | | 4″ | | 5″ | | 6″ | | 8″ | | 10″ | |
| | Uniform Load | | | | | | | | | | | | | | | |
| | 5.2 psf | | 10.4 psf | | 15.6 psf | | 20.8 psf | | 26.0 psf | | 31.2 psf | | 41.6 psf | | 52.0 psf | |
| Span (Ft) | L/D | FOS | L/D | FOS | L/D | FOS | L/D | FOS | L/D | FOS | L/D | FOS | L/D | FOS | L/D | FOS |
| 8 | >360 | >6 | >360 | >6 | >360 | >6 | 280 | >6 | 224 | >6 | 187 | >6 | 140 | 4.9 | 112 | 3.9 |
| 9 | >360 | >6 | >360 | >6 | 262 | >6 | 197 | >6 | 157 | >6 | 131 | 5.2 | 98 | 3.9 | 79 | 3.1 |
| 10 | >360 | >6 | 287 | >6 | 191 | >6 | 143 | >6 | 115 | 5.0 | 96 | 4.2 | 72 | 3.2 | | |
| 11 | >360 | >6 | 215 | >6 | 144 | >6 | 108 | 5.2 | 86 | 4.2 | 72 | 3.5 | | | | |
| 12 | 332 | >6 | 166 | >6 | 111 | 5.8 | 83 | 4.4 | 66 | 3.5 | | | | | | |
| 13 | 261 | >6 | 130 | >6 | 87 | 5.0 | 65 | 3.7 | | | | | | | | |
| 14 | 209 | >6 | 104 | >6 | 70 | 4.3 | | | | | | | | | | |
| 15 | 170 | >6 | 85 | 5.6 | | | | | | | | | | | | |
| 16 | 140 | >6 | 70 | 4.3 | | | | | | | | | | | | |
| 17 | 117 | >6 | | | | | | | | | | | | | | |
| 18 | 98 | >6 | | | | | | | | | | | | | | |
| 19 | 84 | >6 | | | | | | | | | | | | | | |
| 20 | 72 | >6 | | | | | | | | | | | | | | |

Maximum spans are based on each panel being fastened with three (3) bolts to each support.

Design of FRP Baffle Wall-D Series

(1) Design Load (greater of water differential or wind load), which include water differential (uniform load over wall), and wind load (uniform load).

(2) Deflection Limit and Factor of Safety, which includes baffle panels (L/D, Max Defl=Panel Depth, FOS=2.0), and columns: (L/D=100, FOS=2.5).

Materials of FRP Baffle Panels, Columns, and Angles-D Series

1). FRP baffle panels, columns, angles, and associated components may be ANSI/NSF Standard 61 certified for potablewater application (as required).

2). FRP Baffle Panels may exhibit these minimum properties:

| | |
|---|---|
| Stiffness (EI) | 5,591,000 lb-in²/ft |
| Moment Capacity | 19,700 lb-in/ft |

3). FRP structural materials may exhibit these minimum properties:

| | | |
|---|---|---|
| Tensile Strength | 40,000 psi | ASTM D 638 |
| Flexural Strength | 33,000 psi | ASTM D 790 |
| Flexural Modulus | 1,037,000 psi | ASTM D 790 |
| Izod Impact (Notched) | 15 | ASTM D 256 |
| Water Absorption | 0.2% maximum | ASTM D 570 |

4). FRP Materials may include UV stabilized polyester resin; surfacing veil at top and bottom sides; gray color.

5). Factory cut edges and drilled holes may be sealed with ANSI/NSF approved material.

6). FRP baffle panels may be Series D, 4×0.125 profile; 4″ depth; ⅛″ nominal thickness; 40% glass fiber reinforcing (by wt.); with top, horizontal ribs sloped downward not less than 10 degrees to minimize sediment build-up.

7). FRP Columns may be a type with 50% glass fiber reinforcing (by wt.). Column base plates or angles may be 304/316 Stainless Steel.

8). FRP Angles may be ⅜″ thick and 90 degrees.

Hardware-D Series

i). Fasteners, anchors, and other structural hardware may be 304/316 Stainless Steel.

ii). Submerged anchors may be epoxy adhesive type.

“H” Structural Baffle and Partition Walls

(System Overview)

As a global leader for FRP structural systems, Applicant developed the “H” Series baffle panel and the innovative SlideGuide assembly system.

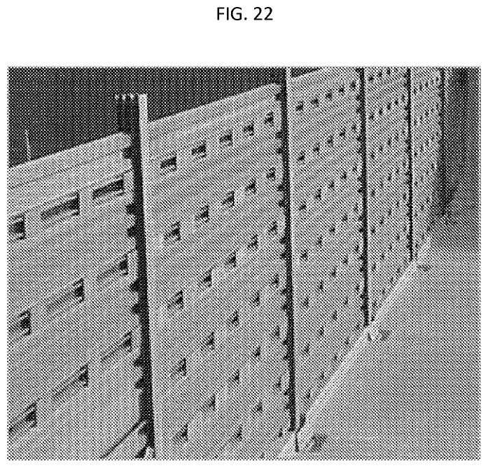

FIG. 21 shows a profiled section of “H” structural baffle wall. FIG. 22 shows “H” structural baffle wall system. FIG. 22 shows “H” slotted flow-thru baffle wall system, settling basin. The ¼″ thick, “H” series are the strongest FRP baffle panels available and are utilized in both bolted and non-bolted installations. In the SlideGuide system, the “H” baffle panels, which do not require fastening, are inserted between and held in place by FRP angles. With a long and proven track record of outstanding performance, the “H” series and SlideGuide assembly has led a movement away from concrete and wood to the Endure FRP baffle system.

Representative Details

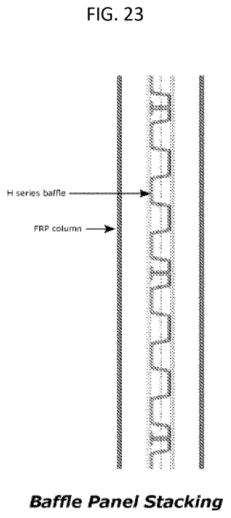

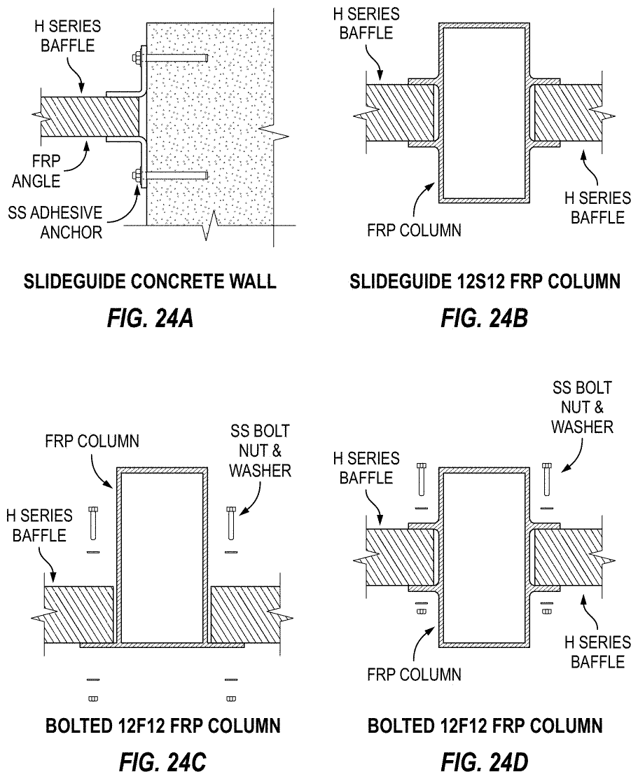

FIG. 23 shows baffle panel stacking. FIG. 24 shows Slideguide concrete wall; Slideguide 12S12 FRP column; bolted 12F12 FRP column; and bolted 12S12 FRP column.

Table 2 shows load span of the “H” structural baffle and partition walls.

TABLE 2
Load Span Table

| | Water Differential | | | | | | | | | | | | | | | |
|---|---|---|---|---|---|---|---|---|---|---|---|---|---|---|---|---|
| | 2″ | | 3″ | | 4″ | | 5″ | | 6″ | | 8″ | | 10″ | | 12″ | |
| | Uniform Load | | | | | | | | | | | | | | | |
| | 10.4 psf | | 15.6 psf | | 20.8 psf | | 26.0 psf | | 31.2 psf | | 41.6 psf | | 52.0 psf | | 62.4 psf | |
| Span (Ft) | L/D | FOS | L/D | FOS | L/D | FOS | L/D | FOS | L/D | FOS | L/D | FOS | L/D | FOS | L/D | FOS |
| 9 | >360 | >6 | >360 | >6 | >360 | >6 | >360 | >6 | >360 | >6 | 300 | >6 | 247 | >6 | 206 | 5.2 |
| 10 | >360 | >6 | >360 | >6 | >360 | >6 | >360 | >6 | 300 | >6 | 226 | >6 | 180 | 5.0 | 150 | 4.2 |
| 11 | >360 | >6 | >360 | >6 | 339 | >6 | 271 | >6 | 226 | >6 | 169 | 5.2 | 135 | 4.2 | 113 | 3.5 |
| 12 | >360 | >6 | 348 | >6 | 261 | >6 | 209 | >6 | 174 | 5.8 | 130 | 4.4 | 104 | 3.5 | | |
| 13 | >360 | >6 | 273 | >6 | 205 | >6 | 164 | 5.9 | 137 | 5.1 | 103 | 3.7 | | | | |
| 14 | 328 | >6 | 219 | >6 | 164 | >6 | 133 | 5.1 | 109 | 4.5 | | | | | | |
| 15 | 267 | >6 | 178 | >6 | 134 | 5.6 | 107 | 4.5 | | | | | | | | |
| 16 | 220 | >6 | 147 | >6 | 110 | 4.9 | | | | | | | | | | |
| 17 | 183 | >6 | 122 | 5.8 | 92 | 4.3 | | | | | | | | | | |
| 18 | 155 | >6 | 103 | 5.2 | | | | | | | | | | | | |
| 19 | 131 | >6 | | | | | | | | | | | | | | |
| 20 | 113 | >6 | | | | | | | | | | | | | | |
| 21 | 97 | 5.7 | | | | | | | | | | | | | | |

Maximum spans are based on non-fixed connection with panels being restrained by SlideGuide angles on each side.
Please contact Enduro for Load/Span data with a bolted H Series installation.

Design of FRP Baffle Wall-H Series

(1) Design Load (greater of water differential or wind load), which include water differential (uniform load over wall), and wind load (uniform load).

(2) Deflection Limit and Factor of Safety, which includes baffle panels (L/D, Max Defl=Panel Depth, FOS=2.0), and columns: (L/D=100, FOS=2.5).

Materials of FRP Baffle Panels, Columns, and Angles-H Series

1). FRP baffle panels, columns, angles, and associated components may be ANSI/NSF Standard 61 certified for potablewater application (as required).

2). FRP Baffle Panels may exhibit these minimum properties:

| | |
|---|---|
| Stiffness (EI) | 17,500,000 lb-in²/ft |
| Moment Capacity | 99,000 lb-in/ft |

3). FRP structural materials may exhibit these minimum properties:

| | | |
|---|---|---|
| Tensile Strength | 48,000 psi | ASTM D 638 |
| Flexural Strength | 58,000 psi | ASTM D 790 |
| Flexural Modulus | 3,210,000 psi | ASTM D 790 |
| Izod Impact (Notched) | 25 | ASTM D 256 |
| Water Absorption | 0.2% maximum | ASTM D 570 |

4). FRP Materials may include UV stabilized polyester resin; surfacing veil at top and bottom sides; gray color.

5). Factory cut edges and drilled holes may be sealed with ANSI/NSF approved material.

6). FRP baffle panels may be Series H, 2.75×25 profile; 2.75″ depth; ¼″ nominal thickness; 50% glass fiber reinforcing (by wt.); with top, horizontal ribs sloped downward not less than 10 degrees to minimize sediment build-up.

7). FRP Columns may be a type with 50% glass fiber reinforcing (by wt.). Column base plates or angles may be 304/316 Stainless Steel.

8). FRP Angles may be ⅜″ thick and 90 degrees.

Hardware-H Series

i). Fasteners, anchors, and other structural hardware may be 304/316 Stainless Steel.

ii). Submerged anchors may be epoxy adhesive type.

Table 3 shows corrosion resistance about resin systems. Two standard composite resin systems are available. For most applications, isophthalic polyester fire-retardant (FR-P) is the more widely used. A vinyl ester composite fire-retardant resin system (FR-VE) is recommended where strong acids (such as hydrochloric acid), strong alkalies (such as caustic soda), organic solvents and halogenated organic conditions exist. An abbreviated Guide is provided below to assist in the selection of the proper resin system for individual application.

TABLE 3

| Chemicals | 70° F. | 160° F. |
|---|---|---|
| Acetic Acid 5% | FR-P | FR-P |
| Acetic Acid 25% | FR-P | FR-VE-210° (*) |
| Ammonium Hydroxide 10% | FR-P | FR-VE-150° |
| Ammonium Nitrate | FR-P | FR-P |
| Calcium Chloride | FR-P | FR-P |
| Chlorine Dioxide 15% | FR-P | FR-VE-150° (*) |
| Chromic Acid 5% | FR-P | FR-VE-150° (*Call) |
| Diesel Fuel No. 1 | FR-P | FR-P |
| Diesel Fuel No. 2 | FR-P | FR-P |
| Ethylene Glycol | FR-P | FR-P |
| Fatty Acids [symbol] % | FR-P | FR-P |
| Ferric Chloride | FR-P | FR-VE |
| Hydrochloric Acid 1% | FR-P | FR-P |
| Hydrochloric Acid 15% | FR-P | FR-VE-180° (*) |
| Hydrochloric Acid 37% | FR-P | FR-VE-150° (*) |
| Hydrogen Sulfide | FR-P- [symbol] | FR-VE-210° |
| Magnesium Chloride | FR-P | FR-P |
| Methyl Alcohol 10% | FR-P | FR-VE-150° (*) |
| Nitric Acid [symbol] % | FR-P | FR-P |
| Nitric Acid 20% | FR-VE | FR-VE-120° (*) |
| Phosphoric Acid 10% | FR-P | FR-P |
| Phosphoric Acid 30% | FR-P | FR-P |
| Phosphoric Acid 85% | FR-P | FR-P |
| Sodium Bisulfate | FR-P | FR-P |
| Sodium Carbonate | FR-P | FR-VE |
| Sodium Chloride | FR-P | FR-P |
| Sodium Hydroxide [symbol] % | FR-VE | FR-VE-120° (*) |
| Sodium Hypochloride 5% | FR-P | FR-VE-120° (*) |
| Sulfuric Acid 0-30% | FR-P | FR-P |
| Sulfuric Acid 30-50% | FR-VE | FR-VE |
| Sulfuric Acid 50-70% | FR-VE | FR-VE-180° (*) |

FR = Fire-Retardant;
P = Polyester Resin;
VE = Vinyl Ester Resin;
(*) = Not recommended to exceed this temperature;
Call = Call for recommendations. [symbol]
indicates data missing or illegible when filed

Information contained in the table 3 is based on data from raw material suppliers and collected from several years of actual industrial applications. Temperatures are not the minimum nor the maximum (except where specifically stated) but represent standard test conditions. The products may be suitable at higher temperatures, but individual test data should be required to establish such suitability. The recommendations or suggestions contained in the table 3 are made without guarantee or representation as to results.

Table 4 shows typical properties of structural FRP.

TABLE 4

| | | |
|---|---|---|
| Mechanical ( [symbol] ) | FR-P | FR-VE |

Longitudinal Direction

| | | |
|---|---|---|
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | | |
| [symbol] | | |

Electrical

| | | |
|---|---|---|
| [symbol] | [symbol] | [symbol] |
| [symbol] | | |
| [symbol] | [symbol] | [symbol] |
| [symbol] | [symbol] | [symbol] |
| [symbol] | [symbol] | [symbol] |
| [symbol] | [symbol] | [symbol] |

Fire Retardant Properties

| [symbol] | [symbol] | [symbol] |
|---|---|---|
| [symbol] | [symbol] | [symbol] |
| [symbol] | [symbol] | |
| | [symbol] | |
| [symbol] | [symbol] | [symbol] |
| [symbol] | | |

Transverse Direction

| | | |
|---|---|---|
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | | |
| [symbol] | [symbol] | [symbol] |

Full Sections in Bending

| | | |
|---|---|---|
| [symbol] | [symbol] | [symbol] |
| [symbol] | [symbol] | [symbol] |
| [symbol] | [symbol] | [symbol] |

Thermal

| | | |
|---|---|---|
| [symbol] | [symbol] | [symbol] |
| [symbol] | | |
| [symbol] | [symbol] | [symbol] |
| [symbol] | | |
| [symbol] | [symbol] | [symbol] |

Other

| | | |
|---|---|---|
| [symbol] | [symbol] | [symbol] |
| [symbol] | [symbol] | [symbol] |
| [symbol] | [symbol] | [symbol] |
| [symbol] | | |

[symbol]

[symbol]

indicates data missing or illegible when filed

What is claimed is:

1. A pressure relief door for a waste water treatment system wherein the pressure relief door comprises:
a pressure relief door frame configured to be attached to a baffle wall or a tank floor or a tank cover; and
a pressure relief door cover attached to the pressure relief door frame;
wherein the pressure relief door cover is configured to open when a pressure on the pressure relief door cover exceeds a predetermined pressure.

2. The pressure relief door of claim 1, further comprising a gasket positioned between the pressure relief door frame and the pressure relief door cover wherein the gasket is configured to seal the pressure relief door frame and the pressure relief door.

3. The pressure relief door of claim 1, further comprising an axle on the pressure relief door cover wherein the axle is configured to allow for opening and closing of the pressure relief door cover.

4. The pressure relief door of claim 1, further comprising a stop mounted on the pressure relief door frame wherein the stop is configured to limit rotation of the pressure relief door.

5. The pressure relief door of claim 1, wherein the pressure relief door frame comprises a bottom base which is configured to be attached to a tank floor

6. The pressure relief door of claim 3, further comprising a bushing, a bearing, or a combination thereof wherein said bushing, bearing, or combination is configured to support and position the axle.

7. The pressure relief door of claim 1, wherein the pressure relief door frame is configured to be rigidly anchored to a baffle wall or a tank floor or a tank cover.

8. The pressure relief door of claim 1, further comprising at least one torsion spring attached to the pressure relief door cover wherein the at least one torsion spring is configured to allow the pressure relief door to open when the pressure on the pressure relief door cover exceeds a predetermined pressure.

9. The pressure relief door of claim 1, further comprising one or more restraining clamps attached to the torsion spring.

10. A pressure relief door for a waste water treatment system wherein the pressure relief door comprises:
a pressure relief door frame configured to be attached to a baffle wall or a tank floor or a tank cover;
a pressure relief door cover attached to the pressure relief door frame with a hinge and axle; and
at least one torsion spring attached to the pressure relief door cover;
wherein the at least one torsion spring is configured to only allow the pressure relief door to open when the pressure on the pressure relief door cover exceeds a predetermined pressure.
